(19) United States
(12) Patent Application Publication
(10) Pub. No.: US 2006/0001188 A1
(43) Pub. Date: Jan. 5, 2006

(54) Manufacturing method for polymer chips containing metal or metal oxide nanoparticles component

(76) Inventors: Shin-Hsin Chang, Shengang Township (TW); Wei-Jen Lai, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/140,912

(22) Filed: Jun. 1, 2005

Related U.S. Application Data
(62) Division of application No. 10/623,550, filed on Jul. 22, 2003.

(51) Int. Cl. C08G 63/48

(52) U.S. Cl. 264/104; 524/543; 525/11; 525/100; 428/403; 428/328

(57) ABSTRACT

A manufacturing method with respect to polymer chips containing metal or metal oxide nanoparticles component discloses the chips, treated by blend and extrude, composed of one metal or metal oxide nanparticles and at least one polymer material. The metal or metal oxide nanoparticles disperse into polymer chip and by spinning, textile process to be as antibiosis textiles, e.g. fiber, yarn, woven or non-woven or to be as plastic process materials. Meanwhile, uses metal or metal oxide nanoparticles to achieve functional application, e.g. disinfection, antibiosis, far IR, and so on.

### BACKGROUND OF THE INVENTION

1. Field of the Invention

The present invention relates to a manufacturing method with respect to polymer chips containing metal or metal oxide nanoparticles component. More particularly, the chips are composed of one metal or metal oxide nanomaterial and at least one polymer material, for producing functionality products, for example, disinfection, antibiosis, far IR and so on.

2. Description of the Related Art

Nanotechnology is studying about nano scale science, that is, the size of one-billionth meter related technology and products. Because of the quantum-size and surface effect, in nano scale, the materials have many amazing physical and chemical properties. That's different with bulkmateriale or molecule materials. And, when the materials are shrunk to nanoscale and produced numerous characteristics and functions. That's called nanotechnology.

By industry development, the weather is also changed. This kind of moisture environment multiplies a great quantity microbe. Any microbe that survives in the environment is maybe pathogen. These microbes could make human have a disease, e.g. staphylococcus induces pneumonia, meningitis and skin infection and demobilized soldier disease bacillus induces demobilized soldier disease.

Because bacteria did great harm to human, control bacteria growing, protect health of human and increate life and economic benefit are important and imperative. Due to science progressing, the antibacterial products not only to be used on individual health care and family clean appliance, also to be popularized for clothing and textiles. The final purpose of antibacterial textiles is to be the protective screen as the third layer skin and control microbes effectively. We will have a comfortable and pleasant life and meanwhile ensure our health.

In current marketing, the antibacterial agent of clothing is categorized in two types: organic systems and inorganic systems. In organic antibacterial agents, the positive charged tetra-amine salts are major components but in inorganic ones, metal ions, e.g. Ag⁺, Cu²⁺, Zn²⁺ etc., are major components.

The antibiosis fabric is manufactured by two methods: using antibiosis fiber to manufacture various fabrics or fabric to progress textile-finish process (e.g. dipping or coating) by antibacterial agent to obtain antibiosis effect. Compare both differences, the former has permanent antibiosis effect and washability, but antibiosis fiber isn't manufactured easily and it has higher request for antibacterial agent; the latter is easier to process, but the valid component curing on fiber surface, so it'll easier to break away through more washings and reduce deodorization function. The antibiosis effect that antibiosis materials of metal ions and antibiosis materials containing metal component has a big difference.

Thus, for a long time, users and the inventor hope for a brand new material of polymer chips containing metal nanoparticles and its manufacturing method. It not only can improve the drawback of conventional functionality products by finish process but also can increase the functionality. This inventor devoted himself to be engaged in studying, development and sales experience on related products for many years. So initiating a thought for improvement and using personal professional knowledge to study, design, special subject investigation. Finally, study a manufacturing method of polymer chips containing metal or metal oxide nanoparticles component to solve problems mentioned above.

### SUMMARY OF THE INVENTION

It is an object of the present invention to provide a manufacturing method of polymer chips containing metal or metal oxide nanopacticles to be a raw material for spinning or plastic process and to be as antibiosis textiles, e.g. fiber, yarn, woven or non-woven and uses metal or metal oxide nanoparticles to achieve functional application, e.g. disinfection, antibiosis, far IR and so on.

It is another object of the present invention to provide a manufacturing method of polymer chips containing metal or metal oxide nanopacticles. The metal or metal oxide nanopacticles are dispersed into polymer materials to be as polymer chips and by adding less metal or metal oxide nanoparticles to achieve functional effect, e.g. disinfection, antibiosis and far IR and so on.

It is yet another object of the present invention to provide a manufacturing method of polymer chips containing metal or metal oxide nanoparticles. The metal or metal oxide nanoparticles are added into polymer materials to be as polymer chips. The function of metal or metal oxide nanoparticles atom cluster can not be reduced functionality loss after washing, it improve permanency of functionality.

In this invention displays a manufacturing method of metal or metal oxide nanoparticles polymer chips. We add metal or metal oxide nanoparticles into one polymer material to form a well dispersed metal or metal oxide nanoparticles polymer chips and let metal or metal oxide nanoparticles become as one of parts of textiles or the materials in plastic process. And the products won't reduce functionality by washing.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an illustrate view showing a manufacturing flow for sliver nanoparticles polymer chips in accordance to an embodiment of the present invention;

FIG. 2 is an illustrate view showing a pressure test for sliver nanoparticles polymer chips in accordance to an embodiment of the present invention; and

FIG. 3 is an illustrate view showing a SEM image for sliver nanoparticles PBT fiber in accordance to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The conventional technique is to use dipping or coating of textile-finish process to put additional functionality material onto textile, it could reduce antibacterial effect caused by washing. These kinds of process can't keep function on textile permanently.

This invention provides an innovative process method for polymer chips. Putting nanometer material into polymer material to produce a well dispersed nano-polymer chips and nanoparticle turn into one part of textile naturally. It doesn't affect functionality by washing.

The polymer materials of this invention include polyamide, polyester (e.g. PBT, PET, PTT, PPT), polyethylene (PE), polypropylene (PP), polycarbonate (PC), polystyrene (PS), polyacrylonitrile, cellulose, and so on.

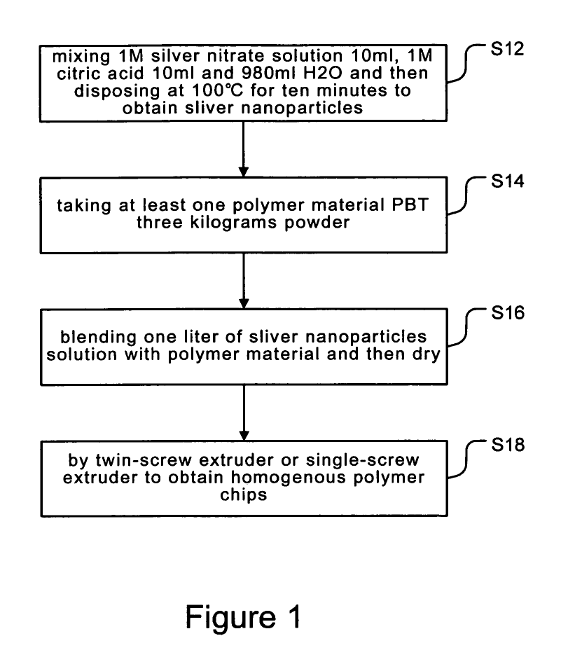

Functional metal or metal oxide nanoparticles are very more variety, the antibiosis material in this invention is an example. Multiple metal ions could be produced as metal nanoparticles, including metal ions (e.g. Au, Ag, Cu, Zn, Ti, Pd, Pt, Fe, Zr), oxide, and composite. Among the metal ions, the inhibitory action of Ag for bacteria is strongest. So use Ag as metal nanoparticles material in this invention. The manufacturing method of sliver nanoparticles polymer chips is shown as FIG. 1. The process flow of polymer chips in accordance to an embodiment of the present invention is illustrated as follows,
Step S12: mixing 1M silver nitrate solution 10 ml, 1M citric acid 10 ml and 980 ml H2O and then disposing at 100° C. for ten minutes to obtain sliver nanoparticles;
Step S14: taking at least one polymer material PBT three kilograms powder;
Step S16: blending one liter of sliver nanoparticles solution with polymer material and then dry; and
Step S18: by twin-screw extruder or single-screw extruder to obtain homogenous polymer chips.

The sliver nanoparticles polymer chips in accordance to an embodiment of the present invention also can do the spinning process. Before spinning, polymer chips need to do pressure test to assure whether further spinning or not. The pressure test condition of polymer chip is one kilogram well dispersed sliver nanoparticles polymer chip need pass filter test, wherein the filter is 400 mesh, speed rate is 100 RPM and proper temperature (Nylon, PBT: 260° C. and PET: 280° C.).

After pressure test for the PBT polymer chip, it can progress spinning if pressure-ascend-value is smaller than 10 bar/Kg. The spinning step as follows: to blend spinning polymer and sliver nanoparticles polymer chips in accordance to an embodiment of the present invention or to use sliver nanoparticles polymer chips to dry and progress spinning at 260-290° C. by single-screw or twin-screw extruder as Partially Oriented Yarn(POY) and through twist process or drawn process to manufacture as sliver nanoparticles yarn. Final, sliver nanoparticles woven fabric or knit fabric will be produced.

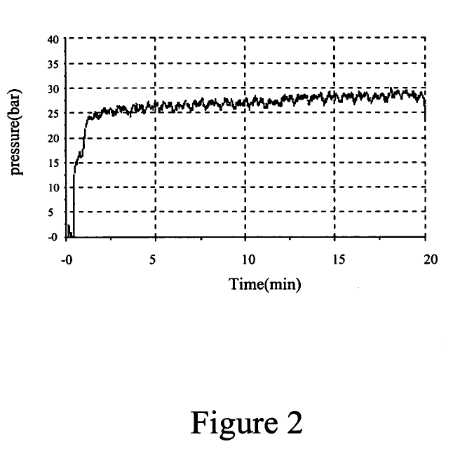

The pressure test result of sliver nanoparticles polymer chips in this invention is shown as FIG. 2. In this pressure test figure, vertical axis is pressure and horizontal axis is time. The pressure of containing well dispersed sliver nanoparticles PBT chip's pressure-ascend-value is 5 bar/Kg. That means sliver nanoparticles PBT chips in this invention are proper to progress spinning and has business value.

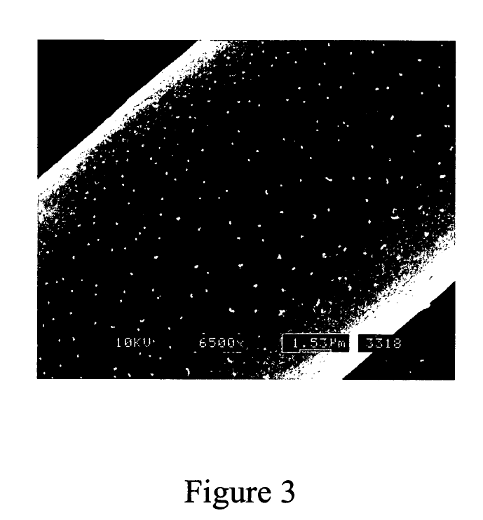

The present invention uses scanning electron microscope (SEM) to observe sliver nanoparticles distribution of partially-oriented yarn. FIG. 3 is a SEM image of containing sliver nanoparticles PBT fiber. It shows distribute uniformly of sliver nanoparticles in PBT fiber. That means present invention provides a good method of well dispersed nanoparticles component in polymer material and manufactures stable quality of textiles.

The containing sliver nanoparticles PBT woven fabric and sliver nanoparticles knit fabric are produced by spinning process or twist process or drawn process in present invention and white cottons are all progress antibacterial test by international standard “JIS L1902-1998 Testing for antibacterial activity and efficacy on textile products”. The test germs are golden staphylococcus (ATCC 6538P) and pneumobacillus (ATCC 4352). The test items are: 1. germ culturing concentration; 2. Ma: put germ solution on un-process white cotton and wash it immediately and then calculate germ numbers; 3. Mb: put germs solution on un-process white cotton and 25 after culturing eighteen hours, washing and calculate germ numbers; 4. Mc: after culturing eighteen hours, the test sample (containing sliver nanoparticles fiber) washing and calculating germ numbers.

According to test data, further to calculate related index, e.g., bacteria grow up activity value, bacterioustasis value and disinfection value to judge the antibiosis of sample. For containing sliver nanoparticles PBT woven fabric and containing sliver nanoparticles PBT knit fabric in this invention, there have obvious effect on antibiosis and disinfection. Please refer to table I and table II, the antibacterial test result of containing sliver nanoparticles PBT woven fabric and containing sliver nanoparticles PBT knit fabric, respectively. In table I, for the antibacterial test of golden staphylococcus, the germ culturing concentration of white cotton and sliver nanoparticles PBT woven fabric are 0.72E+5 germ number/ml; for the antibacterial test of pneumobacillus, the germ culturing concentration of white cotton and containing sliver nanoparticles PBT woven fabric is 0.72E+5 germ number/ml and 0.75E+5 germ number/ml, respectively. It means the germ culturing concentration in this test belong to valid test range. In table I, for the antibacterial test of golden staphylococcus, the bacterioustasis value and disinfection value of white cotton and containing sliver nanoparticles PBT woven fabric is larger than 2.88 and smaller than zero, respectively; for the antibacterial test of pneumobacillus, the bacterioustasis value and disinfection value of white cotton and containing sliver nanoparticles PBT woven fabric is larger than 5.99 and 2.86, respectively.

According to the antibacterial standard of Japan Association for the Function Evaluation of Textile (JAFET), it displays the effect of woven fabric for golden staphylococcus isn't obvious, but for another bacillus, it has obvious bacterioustasis and disinfection effect. Please refer to table 11, for the antibacterial test of golden staphylococcus, the bacterioustasis value and disinfection value of containing sliver nanoparticles PBT knit fabric is larger than 5.8 and 2.99, respectively; for the antibacterial test of pneumobacillus, the bacterioustasis value and disinfection value of containing sliver nanoparticles PBT knit fabric is larger than 5.57 and 3.09, respectively. For golden staphylococcus and pneumobacillus, the knit fabric has obvious bacterioustasis and disinfection effect.

According to mentioned above, by the method in this invention can let sliver nanoparticles component disperse uniformly into polymer material and manufacture as fiber composed by silver nanoparticles. Using this function of component achieves bacterioustasis and disinfection effect.

TABLE I
The antibacterial test result of sliver nanoparticles PBT woven fabric

Test result

| | | | containing |
|---|---|---|---|
| | | | Sliver |
| | | | nanoparticles |
| Test Item (JIS | | | PBT |
| L1902-1998 quantify | | JIS white | woven |
| method) | | cotton | fabric |
| golden | germ | 0.72E+5 | 0.72E+5 |
| staphylococcus | culturing | | |
| ATCC | concentration | | |
| 6538P | Ma | 1.44E+4 | — |
| | Mb | 7.87E+6 | — |
| | Mc | — | 1.81E+4 |
| | bacteria grow | 2.74 | — |
| | up activity | | |
| | value | | |
| | bacterioustasis | — | 2.88 |
| | value | | |
| | disinfection | — | <0 |
| | value | | |
| Pneumobacillus | germ | 0.72E+5 | 0.75E+5 |
| ATCC | culturing | | |
| 4352 | concentration | | |
| | Ma | 1.43E+4 | — |
| | Mb | 1.39E+7 | — |
| | Mc | — | <20 |
| | bacteria grow | 2.99 | — |
| | up activity | | |
| | value | | |
| | bacterioustasis | — | >5.59 |
| | value | | |
| | disinfection | — | 2.86 |
| | value | | |

Remark:
1. Ma: put germ solution on un-process white cotton and wash it immediately and then calculate germ numbers.
2. Mb: put germ solution on un-process white cotton and after culturing eighteen hours, washing and calculate germ numbers.
3. Mc: the test sample (containing sliver nanoparticles fiber).
4. Bacteria grow up activity value is equal to log (Mb/Ma). Bacteria grow up activity value is lager than 1.5, that means the experiment effective.
5. Bacterioustasis value is equal to log (Mb/Mc)

6. Disinfection value is equal to log (Ma/Mc)

TABLE II
The antibacterial test result of sliver nanoparticles PBT knit fabric

| | | Test result | |
|---|---|---|---|
| | | | containing |
| | | | sliver |
| Test Item | | | nanoparticles |
| (JIS L1902-1998 | | JIS | PBT knit |
| quantify method) | | White cotton | fabric |
| golden | germ | 0.99E+5 | 0.99E+5 |
| staphylococcus | culturing | | |
| ATCC 6538P | concentration | | |
| | Ma | 1.97E+4 | — |
| | Mb | 1.25E+7 | — |
| | Mc | — | <20 |
| | bacteria grow | 2.80 | — |
| | up activity | | |
| | value | | |
| | bacterioustasis | — | >5.80 |
| | value | | |
| | disinfection | — | >2.99 |
| | value | | |
| pneumobacillus | germ | 1.24E+5 | 0.75E+5 |
| ATCC 4352 | culturing | | |
| | concentration | | |
| | Ma | 2.49E+4 | — |
| | Mb | 7.47E+6 | — |
| | Mc | — | <20 |
| | bacteria grow | 2.48 | — |
| | up activity | | |
| | value | | |
| | bacterioustasis | — | >5.57 |
| | value | | |
| | disinfection | — | >3.09 |
| | value | | |

Remark:
1.Ma: put germ solution on un-process white cotton and wash it immediately and then calculate germ numbers.
2.Mb: put germ solution on un-process white cotton and after culturing eighteen hours, washing and calculate germ numbers.
3.Mc: the test sample (containing sliver nanoparticlesfiber).
4. Bacteria grow up activity value is equal to log(Mb/Ma). Bacteria grow up activity value is lager than 1.5, that means the experiment effective.
5. Bacterioustasis value is equal to log (Mb/Mc)
6. Disinfection value is equal to log (Ma/Mc)

In this invention, using one metal or metal oxide nanoparticles material and at least one polymer material blend and extrude as polymer chips. The metal or metal oxide nanoparticles disperse into polymer chips and by spinning, textile process to be as antibiosis textiles or plastic process materials. In this invention, we try to replace the conventional technique that the functionality textiles need to be manufactured by finish process. Meanwhile, uses metal or metal oxide nanoparticles to replace metal ions and achieve functionality effect because metal ions are easier loss functionality by washing. And in accordance to an embodiment of the present invention, the fabric with metal atom cluster isn't the same with antibiosis fabric that add by metal ions. Metal ions need to reach some critical concentration and then with bacteriostatic effect. Once washing, concentration of metal ions won't enough and bacteriostatic effect will be loss. But if concentration of metal ions is higher, human will irritability, e.g. Ag ion and Cl ion produce AgCl. As long as fabric has disinfectant function, the numbers of metal cluster won't affect the bacteriostatic effect.

To integrate mentioned above, it shows the purpose and efficacy of this invention provided with advanced and value in industry. Meanwhile, it's a new and hither to unknown invention in current market. So apply for a patent base on patent law.

In accordance to the above mention, therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-2. (canceled)

3. A polymer chip containing metal or metal oxide nanoparticles component, comprising:
at least one metal or metal oxide nanoparticles; and
at least one polymer material;
wherein the metal or metal oxide nanoparticles disperses within polymer chips.

4. The polymer chip in accordance with claim 3, wherein the proportion of metal or metal oxide nanoparticles and polymer material is smaller than 5% (W/W).

5. The polymer chip in accordance with claim 3, wherein the metal or metal oxide nanoparticles material is selected from one of metal ions, e.g., Au, Ag, Cu, Zn, Pd, Pt, Zr, Fe, Ti, oxide, or composite.

6. The polymer chip in accordance with claim 3, wherein the polymer chip is selected from one of polyamide, polyester, alkene, polyacrylonitrile, polycarbonate, polystyrene, or cellulose.

7. The polymer chip in accordance with claim 6, wherein the polyester is selected from one of polybutylene terephthalate (PBT), polyethylene terephthalate (PET), PPT or polytetramethylene terephthalate (PTT).

8. The polymer chip in accordance with claim 6, wherein the alkene is selected from one of polyethylene (PE), or polypropylene (PP).
